(19) United States
(12) Patent Application Publication
(10) Pub. No.: US 2014/0379602 A1
(43) Pub. Date: Dec. 25, 2014

(54) SKILL-DRIVEN EDUCATION MARKETPLACE

(71) Applicant: Apollo Education Group, Inc., Phoenix, AZ (US)

(72) Inventors: Lance J. Nelson, Clyde Hill, WA (US); David Drake Callahan, Lake Stevens, WA (US); James R. Utter, Sammamish, WA (US)

(21) Appl. No.: 14/314,303

(22) Filed: Jun. 25, 2014

Related U.S. Application Data
(60) Provisional application No. 61/839,207, filed on Jun. 25, 2013.

(51) Int. Cl. G06Q 50/20; G06Q 10/00

(52) U.S. Cl. CPC G06Q 50/20; G06Q 10/00
USPC 705/327

(57) ABSTRACT

A method and apparatus for presenting education opportunities, careers, and/or job opportunities to a particular user based, at least in part, on the user's identified skill set. The system produces, based, at least in part, on a person's set of skills, one or more careers and/or job opportunities for which the person is currently qualified and/or for which the person may qualify with the acquisition of one or more additional skills. Further, the system identifies and presents educational courses that would help the user to acquire the skills that the user lacks to qualify for particular desired opportunities.

### CROSS-REFERENCE TO RELATED APPLICATIONS

### Benefit Claim

This application claims the benefit of U.S. Provisional Application No. 61/839,207, filed Jun. 25, 2013, the entire contents of which is hereby incorporated by reference as if fully set forth herein, under 35 U.S.C. §119(e).

### FIELD OF THE DISCLOSURE

The present disclosure generally relates to an online computer system for education opportunities, careers, and/or job opportunities, and, more specifically, to presenting education opportunities, careers, and/or job opportunities to a particular user based, at least in part, on a skill set that is identified for the user.

### BACKGROUND

Many times, desirable careers require specialized training. In order to qualify for such careers, many people attend institutions of higher learning, such as universities or colleges, with a major course of study designed to train people for a particular career. However, not all job-seekers participate in traditional courses of study at institutions of higher learning. Further, a job-seeker may complete a course of study at an institution of higher learning and find that she still lacks certain skills or qualifications that are required for the job-seeker's desired career path.

Seeking a degree from an institution of higher learning may require several years of lost earning potential, and also may require taking educational courses that teach skills that the person already has acquired. A person may also find alternative learning opportunities, such as online educational courses, to teach them the skills that they lack. However, it can be difficult to identify which educational courses to take, and even which skills to pursue. The options for online and independent educational courses are varied, and it can be difficult to identify which educational courses would best help to qualify for a particular job or career. Therefore, it would be beneficial to provide a system that informs a job-seeker of what skills to pursue, and what educational courses would help the job-seeker acquire those skills, in order to qualify for learning, career, and job opportunities that suit the particular person's desired career path.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

The appended claims may serve as a summary of the invention.

### BRIEF DESCRIPTION OF THE DRAWINGS

In the drawings:

FIG. 1 is a block diagram that depicts an example network arrangement for presenting education opportunities, careers, and/or job opportunities to a particular user based, at least in part, on the user's identified skill set.

FIG. 2, FIG. 3, FIG. 4, FIG. 5, FIG. 6, FIG. 7, FIG. 8, FIG. 9 depict one or more graphical user interfaces for presenting education opportunities, careers, and/or job opportunities to a particular user.

FIG. 10 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system is described herein to present education opportunities, careers, and/or job opportunities to a particular user based, at least in part, on the user's identified skill set. The system identifies the person's set of skills. The system then produces, based, at least in part, on the person's set of skills, one or more careers for which the person is currently qualified and/or for which the person may qualify with the acquisition of one or more additional skills. The system further identifies job opportunities for the user based, at least in part, on the user's set of skills and/or a desired career indicated by the user.

Once the system identifies a skill set for a particular user, the system maps the user's skill set to particular opportunities (i.e., educational courses, careers, job categories, job opportunities, etc.). The system identifies opportunities for which the user currently has all of the required or suggested skills, and identifies opportunities for which the user may qualify with the addition of one or more skills. Further, the system identifies and presents educational courses that would help the user to acquire the skills that the user lacks to qualify for particular desired opportunities.

According to an embodiment, the system presents other information about potential opportunities for a user, e.g., salary information for a job opportunity, job category, or career; alternative careers that are similar to careers that the user has expressed interest in; careers that are trending and/or becoming more desirable; user feedback on educational courses; information about the daily tasks for particular careers, job categories, or job opportunities; etc.

According to an embodiment, the system allows a user to identify particular opportunities that the user would like information about, and what skills the user should acquire in order to qualify for the identified opportunities. According to yet another embodiment, the system allows the user to identify another person that the user wishes to emulate and the system identifies what skills the user should acquire in order to attain a skill set similar to the skill set of the identified person.

### Context-Based Help Architecture

Techniques are described hereafter for presenting education opportunities, careers, and/or job opportunities to a particular user based, at least in part, on the user's identified skill set. A skills coordinator service produces web pages that communicate information about education opportunities, careers, and/or job opportunities in light of a user's identified skill set. A client device runs a browser that interprets and displays the web pages.

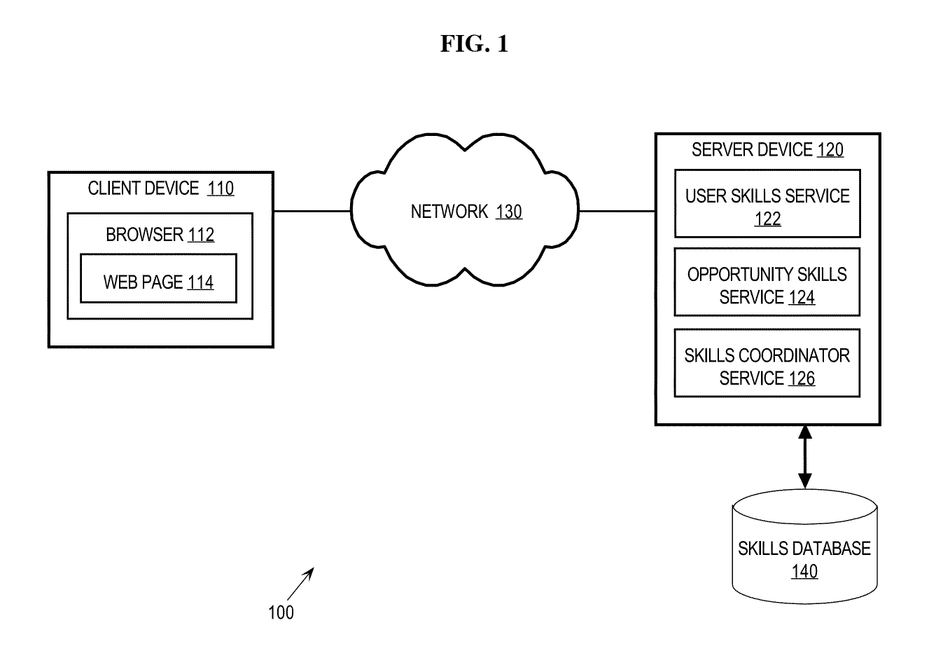

FIG. 1 is a block diagram that depicts an example network arrangement 100 for presenting education opportunities, careers, and/or job opportunities to a particular user based, at least in part, on the user's identified skill set, according to embodiments. Network arrangement 100 includes a client device 110, and a server device 120 communicatively coupled via a network 130. Server device 120 is also communicatively coupled to a skills database 140. Example network arrangement 100 may include other devices, including client devices, server devices, and display devices, according to embodiments. For example, one or more of the services attributed to server device 120 herein may run on other server devices that are communicatively coupled to network 130.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a browser 112 that displays web page 114. Browser 112 is configured to interpret and display web pages (such as web page 114) received over network 130, such as Hyper Text Markup Language (HTML) pages, and eXtensible Markup Language (XML) pages, etc. Client device 110 may be configured with other mechanisms, processes and functionalities, depending upon a particular implementation. Further, client device 110 is communicatively coupled to a display device (not shown in FIG. 1), for displaying graphical user interfaces (e.g., at web page 114). Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may use any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a user skills service 122, an opportunity skills service 124, and a skills coordinator service 126. One or more of services 122-126 may be part of a cloud computing service. Any of services 122-126 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from client device 110 (i.e., via web page 114) or from one of the other services 122-126. Further, any of services 122-126 may send one or more of the following over network 130 to client device 110 or to one of the other services 122-126: information via HTTP, HTTPS, SMTP, etc.; XML data; SOAP messages; API calls; and other communications according to embodiments. Services 122-126 may be implemented by one or more logical modules, and are described in further detail below. Server device 120 may be configured with other mechanisms, processes and functionalities, depending upon a particular implementation.

Server device 120 is communicatively coupled to skills database 140. Skills database 140 may reside in any type of storage, including volatile and non-volatile storage including random access memory (RAM), one or more hard or floppy disks, or main memory, and may be implemented by multiple logical databases. The storage on which skills database 140 resides may be external or internal to server device 120. In one embodiment, skills database 140 stores, as graph database information—e.g., RDF data—skills identified and stored, at least in part, by user skills service 122 and opportunity skills service 124. Skills coordinator service 126 uses the information in skills database 140, at least in part, to map skills to opportunities and to produce web pages.

In an embodiment, each of the processes described in connection with the one or more of services 122-126 are performed automatically and may be implemented using one or more computer programs, other software elements, and/or digital logic in any of a general-purpose computer or a special-purpose computer, while performing data retrieval, transformation and storage operations that involve interacting with and transforming the physical state of memory of the computer.

### Gathering User Skill Data

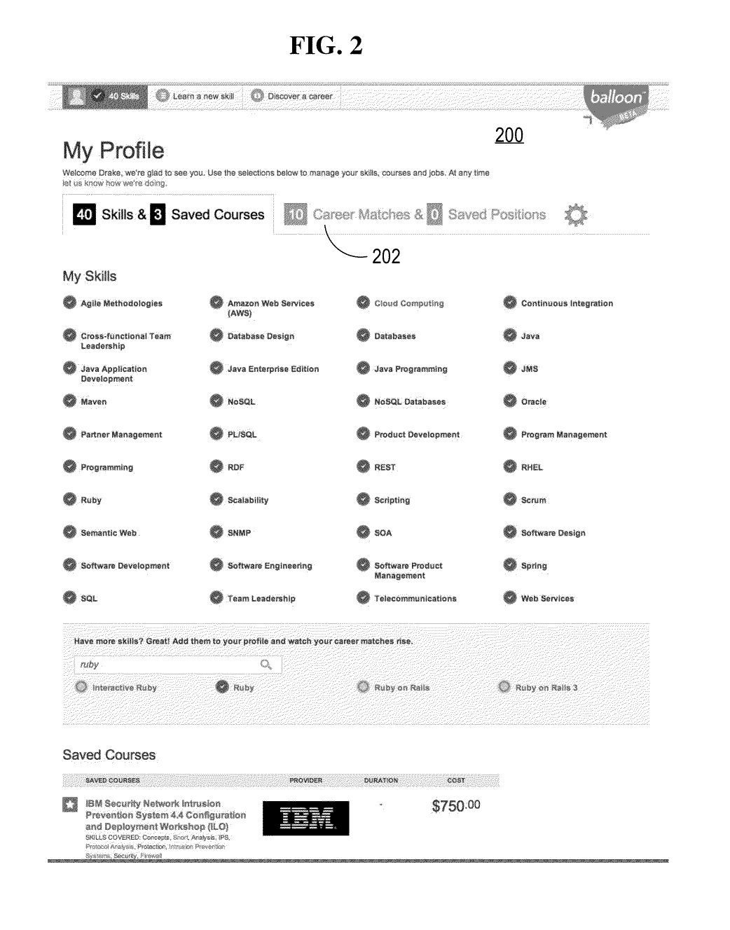

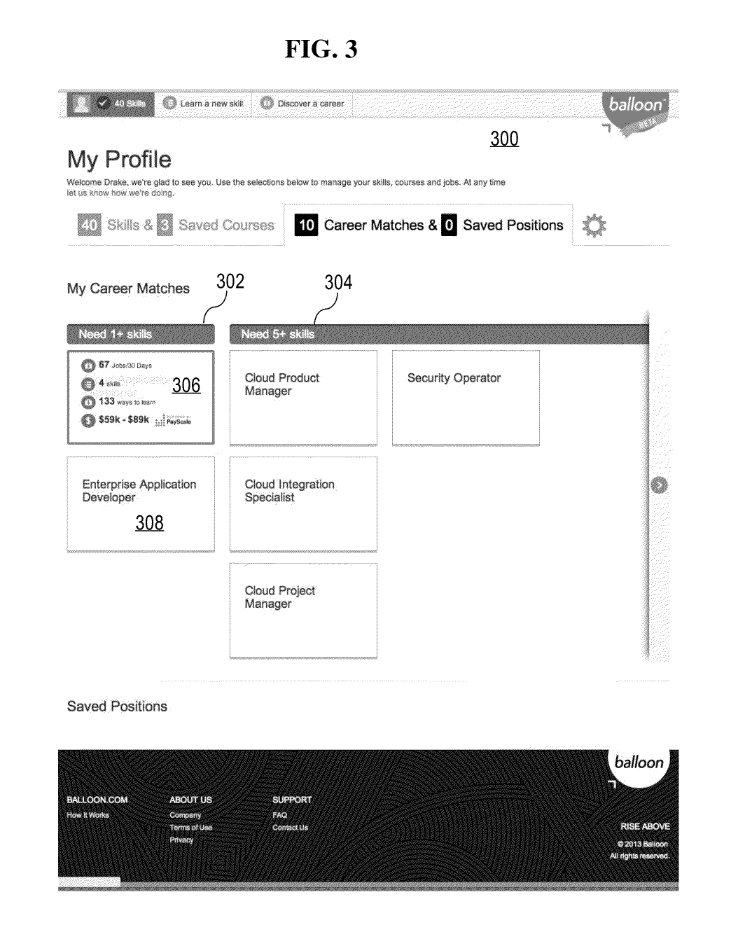

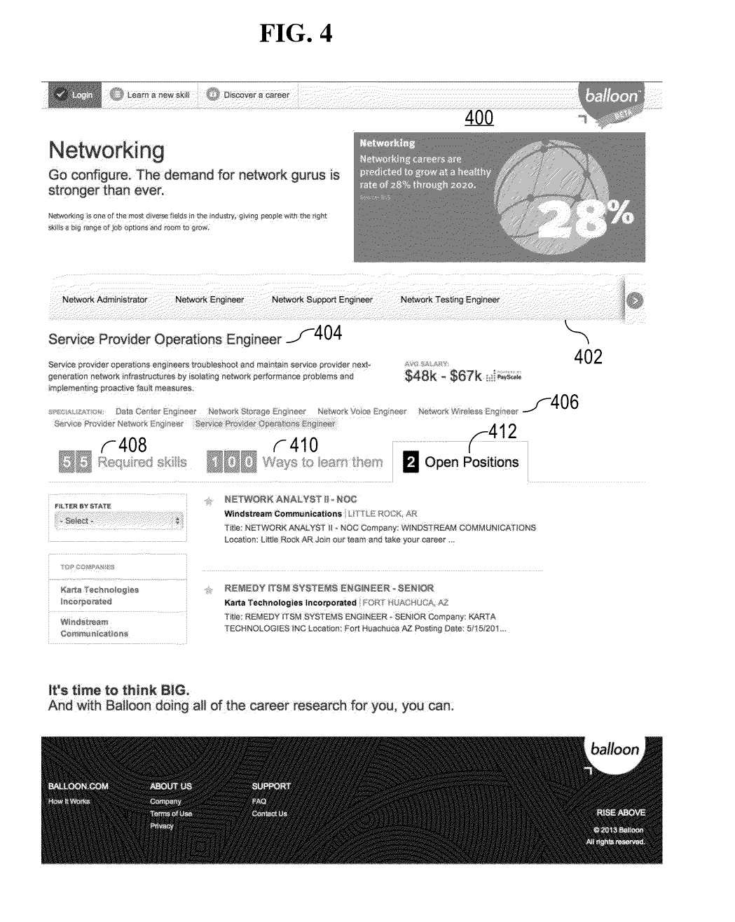

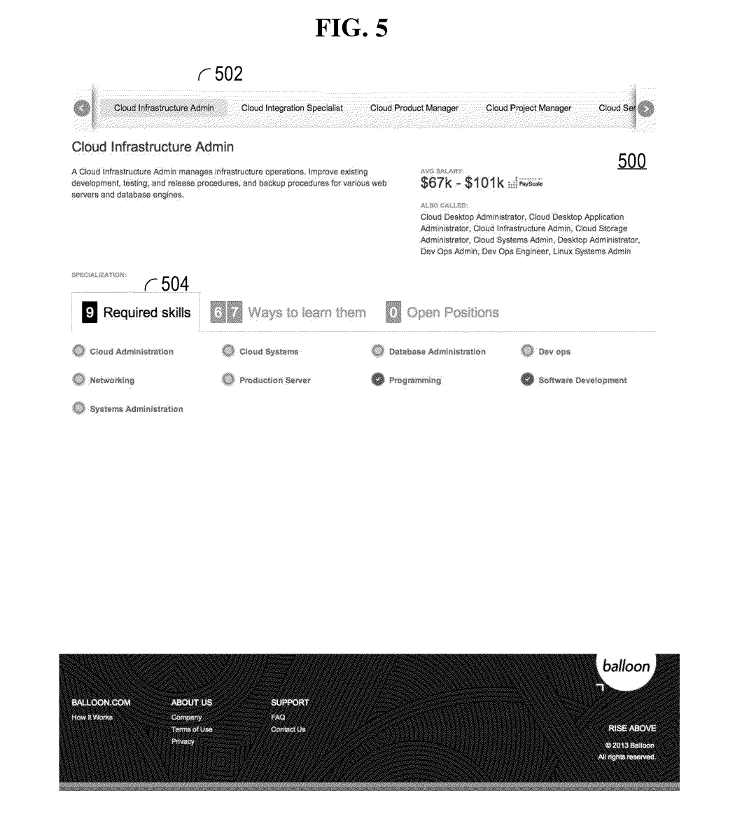

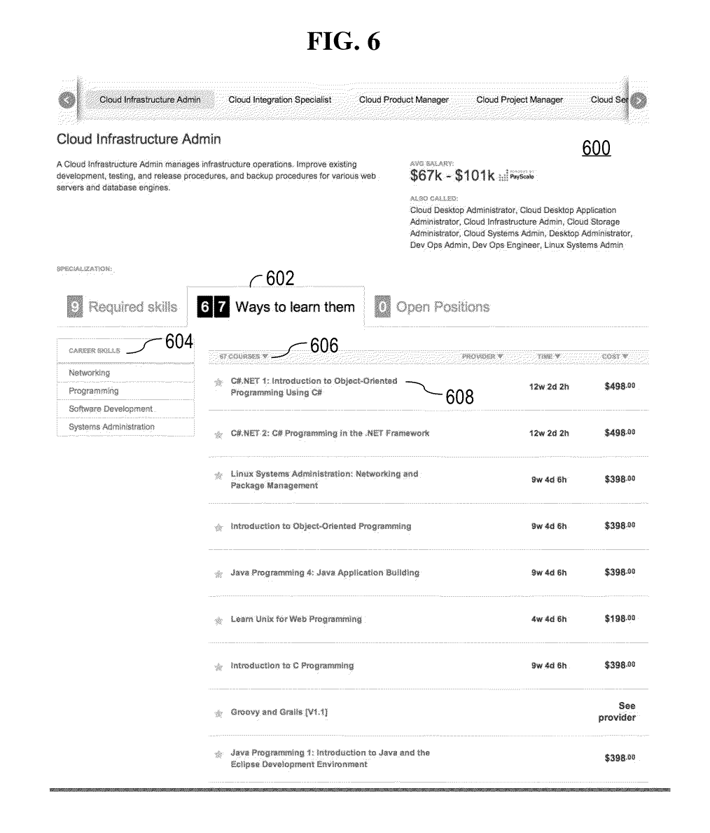

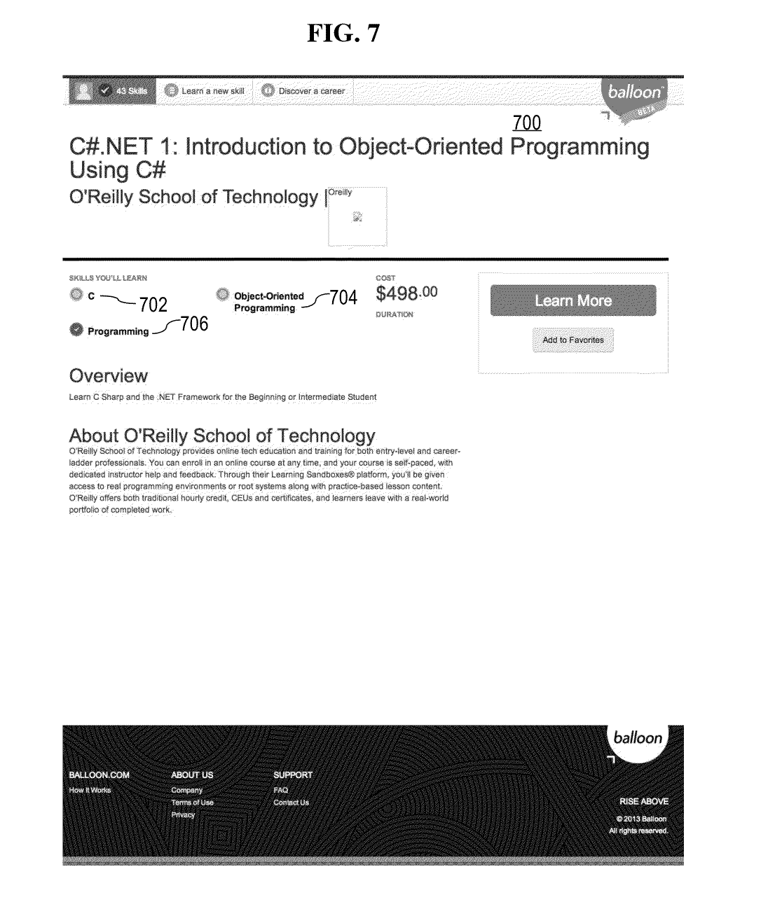

User skills service 122 identifies, and causes to be stored in skills database 140, a set of skills for a particular user. For example, skills coordinator service 126 supplies a web page 114, to client device 110, which web page provides to a user at client device 110 a user skills graphical user interface (GUI), such as GUI 200 of FIG. 2. GUI 200, as well as GUIs 300-900 of FIGS. 3-9, are non-limiting examples of GUIs included in web pages produced and/or supplied by skills coordinator service 126, that may be used in connection with the embodiments described herein.

Through GUI 200, the user provides, to user skills service 122, information by which user skills service 122 may identify a set of skills for the user. According to an embodiment, the user inputs, into GUI 200, information that identifies an online profile of the user. User skills service 122 parses information from the online profile of the user and automatically identifies skills for the user that are declared in or that are able to be inferred from the profile. For example, the user may input, into GUI 200, a Uniform Resource Locator (URL) referring to an online business or professional networking profile, such as a LinkedIn profile found at LinkedIn.com.

According to another embodiment, the user inputs, into GUI 200, a reference to a resume or transcript (or any other source of information) that is accessible online via a URL, or stored at client device 110, etc. User skills service 122 parses the information source to identify skills for the user that are either declared in the information source for the user, or that are able to be inferred from information in the information source.

According to yet another embodiment, the user directly inputs, into GUI 200, values indicating one or more skills of the user. For example, GUI 200 includes a drop down list, populated from a list of possible skills from skills database 140, from which the user may select skills to include in the user's skill set. Furthermore, according to an embodiment, the user may remove or modify information for a skill from the user's skill set, e.g., through GUI 200.

According to yet another embodiment, GUI 200 presents one or more assessments that assess whether the user has one or more particular skills. For example, GUI 200 presents a typing test that measures how fast the user types. User skills service 122 identifies the results of the typing test, e.g., 20 words per minute, as one of the user's skills.

As a further example, GUI 200 refers the user to an external testing service or to the location of an assessment, which skills coordinator service 126 or user skills service 122 automatically determines would provide information that skills coordinator service 126 could use to better determine the user's suitability for particular opportunities. The user may take the external assessment and report the result via GUI 200, or have the result automatically reported to user skills service 122, etc. In an embodiment, the skill information resulting from an independent assessment may be marked as independently determined, and may carry more weight than a self-declared skill for the user.

In an embodiment, the metric used to define a skill level associated with a particular user for a particular skill may be based in part on the skill level of others for the same skill. For example, if user A performs much better on an assessment for the skill than user B and both users self-declare a skill level of “7” for themselves, user skills service 122 may determine that user A, having a better understanding of the subject matter, is a better judge of skill level for that skill. In such a case, user B may show a skill level less than “7” in an effort to normalize the skill level data. Similar comparisons may be made between various groups of users over time, resulting in a more reliable skill level.

User skills service 122 stores the skill set identified for the user in skills database 140. For example, user skills service 122 stores information identifying the skills in the user's skill set in connection with a user profile for the user. Such a user profile, stored at skills database 140, may include other information about the user, according to embodiments, such as a location of the user, desired attributes for education courses (online, in classroom, price range), education courses for which the user has indicated interest, careers for which the user has indicated interest, job opportunities and/or job categories for which the user has indicated interest, etc.

### Gathering Course, Job, and Career Skill Data

Opportunity skills service 124 identifies, and causes to be stored in skills database 140, skills required for particular opportunities. Also, opportunity skills service 124 identifies skills that are taught by particular educational courses, and/or skills that are required as prerequisites to particular educational courses.

According to an embodiment, opportunity skills service 124 receives input from subject matter experts identifying one or more skills that a person generally needs in order to qualify for particular opportunities. Opportunity skills service 124 also receives input from subject matter experts to identify one or more skills taught by particular educational courses, such as online courses, or courses taught at an institution of higher learning, etc.

According to another embodiment, opportunity skills service 124 automatically identifies skills associated with a particular educational course, i.e., skills that are either taught by the course or that are prerequisites for the course. Opportunity skills service 124 identifies skills associated with a particular educational course e.g., by parsing the course title, by parsing published description(s) of the course, through skills declared to be taught by or required for the course, etc.

According to yet another embodiment, opportunity skills service 124 crawls the Internet, i.e., via network 130, to gather data on skills that should be listed as required for opportunities within skills database 140. For example, if opportunity skills service 124 identifies a particular relationship between a particular skill and a particular career via information on the Internet, opportunity skills service 124 may include the information in skills database 140, e.g., as untrusted information, in a queue to be reviewed, as information with a particular level of trustworthiness, etc.

Furthermore, information for available educational courses may be obtained by a web crawler and analyzed by opportunity skills service 124 to identify information about skills that are taught by the courses, skills required by the courses, relationships between the courses and a major course of study, etc. Information about relationships between a particular educational course and a major course of study may allow opportunity skills service 124 to infer that skills taught by a particular course are required for the career associated with the major course of study.

In an embodiment, skills data may be gathered from employers. For example, employers can define particular skills required for jobs, help to refine job-archetypes (or categories), and/or provide feedback on users (typically through an applicant tracking system). For example, user skills service 122 may consider the skills of a user that was hired vs. the skills of applicants that were not hired to help refine skills that are required for a job. User skills service 122 may also compare the skills of users that got interviews vs. those that didn't. When user skills service 122 compares the skills of two users with different outcomes, a skill difference can be determined by determining the skills that the successful user possesses that are not possessed by the unsuccessful user. When the skill difference is compared with the skills required for the position, skills service may determine that one or more skills in the skill difference were important enough to that particular type of job to choose the successful candidate instead of the unsuccessful one.

Skills data may be extracted from job postings in another embodiment. For example, many job postings list skills that an applicant must possess in order to be a successful candidate for the job. By parsing a job posting, skills that are listed in the job posting may be recognized as known skills that are identified in skills database 140. Skills may then be associated with the title of the job posting or any other opportunity (e.g., a job title or an educational course offering) in skills database 140. In an embodiment, a second job posting with the same title (e.g., database administrator) may be associated with the skills detected from the first job posting, even if the second job posting did not list those skills. As more job postings with the same title include the same skills a skills association confidence metric may be adjusted to reflect the confidence that a particular skill should typically be associated with a particular job title. The skills association confidence metric for a skill-title pair may be low if a small number of job postings with a similar title include that skill. Likewise, the skills association confidence metric may be high for a skill-title pair if the number of job postings with a similar title include that skill is high. The skills association confidence metric may be represented by a percentage, number range, letter range, or any other identifier that can express a level. For example, the skills association confidence metric may be represented by low, medium, or high.

As more comparisons are made with respect to different positions and different users, one or more skills in the skill difference may be recognized as skills that are critical for a particular position. When users attempt to apply for such a position, the newly recognized critical skill may be identified and presented as a recommended skill for the applicant. Courses known to teach that particular skill may be identified by determining that one or more candidates successfully obtained or interviewed for a job requiring that skill after having taken the course(s). Such a course may be recommended to a user with a need to acquire that skill.

According to yet another embodiment, opportunity skills service 124 infers skills required for a particular opportunity based, at least in part, on information in skills database 140. For example, if a threshold percentage of people having a particular job title also have a particular set of skills, then opportunity skills service 124 infers that job opportunities with the particular job title require the particular set of skills.

Skills data may be extracted from resumes and online profiles in an embodiment. Resumes and online profiles often list skills that an applicant must possess in order to be a successful candidate for the job. By parsing resumes and online profiles, skills that are listed in the resumes and online profiles may be recognized as known skills that are identified in skills database 140. Skills may then be associated with the title of a job posting or job in skills database 140 in a way similar to that discussed heretofore in conjunction with job postings. Additionally, the skills association confidence metric for a skill-title pair (which may also apply to the title of a job) may be given more weight if the skills are validated by other users of the social network from which the professional profile was extracted. More weight may be given to skill associations that are validated by a larger number of users, users with more credibility, or users for which additional information is known, such as when the validating user is also a user for which assessment data is known.

Opportunity skills service 124 may use any available information to draw connections between entities in skills database 140, e.g., to map skill to skill, or skills to opportunities, or skills to a user, etc. Such information may be saved in skills database 140 at a lesser confidence level, i.e., less than 100%. In this example, a certain piece of information that has been confirmed or supplied by a human has 100% confidence level.

### Presenting Opportunities Based on Skill Information

Skills coordinator service 126 produces web pages with GUIs that present opportunities to a particular user based, at least in part, on the user's identified skill set. For example, as indicated above, in response to a request from the user, skills coordinator service 126 supplies a web page 114, to client device 110, which web page provides to a user at client device 110 a user skills GUI, such as GUI 200 of FIG. 2.

At control 202, GUI 200 provides a mechanism by which the user can view any identified careers for which the user currently has all of the required skills or for which the user lacks one or more of the required skills. When the user activates control 202, skills coordinator service 126 causes a web page 114 with a GUI such as GUI 300 to be sent to client device 110.

Example GUI 300 displays careers for which the user needs one to four additional skills, at column 302, and for which the user needs five to nine additional skills, at column 304. GUI 300 may also display careers for which the user needs no additional skills. Skills coordinator service 126 populates columns 302 and 304 by comparing the skill set known for the requesting user with information in skills database 140 indicating skills that are required for particular careers. GUI 300 may also include a control that allows a user to input a desired career and view information for the desired career, including skills that the user would need to acquire in order to qualify for the input career.

Furthermore, GUI 300 may include a control that allows a user to input desired one or more skills to use in a career, or to be a main focus in a desired career. In response to activation of that control, GUI 300 displays careers that require the indicated skill(s) or that have a main focus of the indicated skill(s). For example, a user may request information about careers with “design” as a required skill. In response, skills coordinator service 126 provides careers that require the “design” skill, e.g., in a manner similar to the careers displayed at GUI 300—according to how many skills the user would need to acquire in order to qualify for the “design”-based careers.

In example GUI 300, career 306 is selected and career 308 is not selected. Because career 308 is not selected, career 308 shows only the title of the career: “Enterprise Application Developer”. Because career 306 is selected, the portion of the GUI displaying career 306 does not show the title (“Networking”), but shows information about the career, e.g., the number of new job opportunities related to the career that were added to the market in the last 30 days, the number of additional skills that the user would need to qualify for the career, the number of “ways to learn” the required additional skills (such as online courses available that teach one or more of the skills), and a range of mean salaries for job categories included in the career (as described in further detail below). In GUI 300, the user may cause any of the displayed careers to be selected in order to see similar summary information as is shown for career 306.

The user may cause GUI 300 to display more information about career 306, e.g., by clicking on the selected career. In response to the request for more information, skills coordinator service 126 causes a web page 114 to be sent to client device 110 with a GUI such as GUI 400 of FIG. 4.

GUI 400 has more information about the “Networking” career, including statistics about growth in the field, similar careers at control 402, a description of the career, etc. GUI 400 also includes the title 404 of a particular selected job category, and a list 406 of specializations (or job categories) associated with the selected career. A job category is a subsection of a particular career, where job opportunities associated with a particular job category are more similar than job opportunities associated with other job categories within the career. The job category selected in GUI 400 is “Service Provider Operations Engineer”.

GUI 400 also includes a control 408 for showing the 55 required skills associated with the job category within skills database 140, a control 410 for showing 100 ways to learn the four skills that the user should acquire in order to qualify for the job category, and a control 412 for showing the two open job opportunities for the selected job category.

According to an embodiment, skills coordinator service 126 identifies job opportunities for a particular job category based on the job category title and any alternate job category titles in skills database 140. According to another embodiment, skills coordinator service 126 identifies job opportunities for a particular job category based on similarities between the skills required for the job category and the skills required for job opportunities.

For example, skills coordinator service 126 identifies that a job opportunity is appropriate for a particular job category when the job opportunity is associated with the exact same skill set as the job category. As another example, skills coordinator service 126 identifies that a job opportunity is appropriate for a particular job category when the skills required for the job opportunity are a subset of the skills required for the job category, or when the job opportunity has only a certain number of skills different than the skills required for the job category, or when the skill sets for the job opportunity and the job category are a statistically significant match. For example, skills coordinator service 126 considers that a particular job opportunity matches a particular job category when the job opportunity has only 5% difference in skill set from the skill set for the particular job category, or when the job opportunity is associated with only 1 or 2 skills different from the particular job category.

GUI 500 displays similar information as is displayed in GUI 400, with details for a “Cloud Computing” career. In the embodiment of GUI 500, the job categories for the displayed career are shown in control 502. A particular job category of “Cloud Computing” is selected, i.e., “Cloud Infrastructure Admin”, and information about the job category is displayed, including information about the duties of the job category, average salary, and alternative names for the job category.

Further, control 504 of GUI 500 displays information for the skills associated with the job category in skills database 140. Specifically, “Cloud Infrastructure Admin” is associated with nine required skills in skills database 140. Skills coordinator service 126 determines that the user already has two of the skills, i.e., “programming”, and “software development”. The user lacks the rest of the nine required skills.

GUI 600 of FIG. 6 displays control 602 having information about “ways to learn” the skills that the user lacks for the “Cloud Infrastructure Admin” job category. Column 604 displays the skills that the user lacks for selected job category and for which skills coordinator service 126 has information about educational courses or other methods for learning the skills. Column 606 shows the available courses, including title, duration, and cost (if available). A user may select one of the skills in column 604, e.g., “networking”, to display a list of available courses that teach the selected skill, as shown in list 802 of GUI 800 (FIG. 8).

According to an embodiment, column 606 of GUI 600 (FIG. 6) shows only courses that would teach the user a skill, for the selected job category, that the user currently lacks. According to another embodiment, column 606 also displays courses that would teach the user only one or more skills that the user currently has, which are required for the desired opportunity. For example, column 606 may display such courses in a different color or visually separated from the courses that would teach the user a required skill that the user does not currently have.

Further, a user may select one of the courses listed in column 606 of FIG. 6 (or column 802 of FIG. 8) to show more information about the course. For example, a user selects course 608, which causes skills coordinator service 126 to produce a web page 114 with GUI 700 of FIG. 7.

GUI 700 shows more information about course 608, including what skills 702-706 the course teaches. GUI 700 further indicates, using associated icons, that the user already has skill 706, “programming”, and that the user requires skills 702 and 704 for the selected job category. This information may help a user determine whether the course would be effective in aiding the user to acquire the desired skills and qualify for the selected job opportunity.

Returning to discussion of GUI 800 of FIG. 8, a user may activate control 804 to view the open positions, or job opportunities, associated with the selected job category. GUI 900 illustrates a job opportunities GUI with a list of job opportunities for the job category at control 902. Control 904 allows the user to filter the job opportunities by state. Furthermore, GUI 900 may allow the user to list the job opportunities based on distance from a particular address or zip code, etc.

According to another embodiment, skills coordinator service 126 provides a user with a list of job opportunities for which the user is currently qualified based on the user's skill set, e.g., in a manner similar to how careers are displayed to the user via GUI 300 of FIG. 3 and subsequent GUIs. Specifically, skills coordinator service 126 populates GUIs such as GUIs 300, 400, and 500 with job opportunity matches instead of with career matches. According to yet another embodiment, skills coordinator service 126 provides a user with a information for job opportunities for which the user would be qualified if the user obtained all of the skills required for a particular opportunity, or if the user obtained all of the skills associated with a designated other person.

### Skills Database

Skills database 140 stores information about particular skills, including relationships between skills. In an embodiment, skills database 140 stores RDF data or other data that indicates that the skill “HTML” is the same as the skills “HTML coding” and “HTML developing”. Skills database 140 also includes descriptive information for the skill “HTML”, and/or a link to a website having descriptive information for the skill “HTML”. Skills database 140 also includes RDF data that indicates that the skill “HTML” is a subset of the skill “Web application development”, and the skill “HTML” is a superset of the skill “CSS”.

According to an embodiment, skills database 140 is implemented as a graph database, e.g., Resource Description Framework (RDF). In the RDF data model, the data is modeled as labeled and directed graphs, represented as a set of triples. The nodes in the graph are used to represent two parts of a given triple, and the third part is represented by a directed link that describes the relationship between the nodes. In the context of an RDF expression, the two nodes are referred to as “subject” and “object” and the link describing the relationship is referred to as “predicate”.

The subject and object of a particular RDF expression may be resources that are identified by Uniform Resource Identifiers (URIs). A predicate is also represented by a URI. A URI includes a prefix that may refer to an electronic location on the Internet, or may refer to a namespace within a database system. For example, standard prefixes “rdf:”, “rdfs:” and “xsd:” are generally defined as follows:

Prefix “rdf:”; namespace URI: http://www.w3.org/1999/02/22-rdf-syntax-ns#

Prefix “rdfs:”; namespace URI: http://www.w3.org/2000/01/rdf-schema#

Prefix “xsd:”; namespace URI: http://www.w3.org/2001/XMLSchema#

Prefixes, such as “ogc:”, and “edb:”, may be defined within a database system to refer to a personal or other namespace in the system.

Instead of a resource, the object of a particular RDF expression may be a literal of some well-defined data type, e.g., “xsd:string”, “xsd:integer”, “xsd:float”, “xsd:double”, “xsd:boolean”, “xsd:dateTime”, “xsd:decimal”, etc. Many literals are found within the “xsd:” namespace, however, literals may be defined within any number of namespaces. An RDF database system generally includes mappings between literals and the corresponding data types as supported by the host database management system. For example, when an RDF database system is implemented as a SQL application, the “xsd: string” data type in RDF may be mapped to a “VARCHAR2” data type in the database management system.

The properties that describe a resource are broadly classified into object-type properties and data-type properties. Object-type properties describe a subject resource, indicated by a URI in the subject position of a triple, using another resource in the object position of the triple, also identified by a URI. On the other hand, a data-type property describes a subject resource using a literal in the object position of the triple. In the following example, Triple 1 is an object-type property and Triple 2 is a data-type property.

```
Triple 1:  <http://www.geonames.org/states/NewHampshire>
    <http://www.geonames.org/pred/hasCity>
    <http://www.geonames.org/cities/Nashua>
Triple 2:  <http://www.geonames.org/cities/Nashua>
    <http://www.geonames.org/pred/hasName> “Nashua”\hat{ }\hat{ }xsd:string
```

According to an embodiment, a skill is associated with level information in skills database 140. For example, a user may have a “5 year experience” level, a “beginner” or “expert” level, or a number on a scale of 1-10 level for the skill “HTML”, etc. Similarly, an opportunity may require a certain level associated with a required skill. For example, a job opportunity may require “at least 4 year experience” level for the “HTML” skill. In this example, the user having a “5 year experience” level of the skill “HTML” would satisfy the requirement of the job opportunity of having “at least 4 year experience” level for the “HTML” skill. According to an embodiment, if the level provided by the user for a particular skill is not in the same units as a level required by a particular opportunity, skills coordinator service 126 requests, from the user, the level for the skill in the required units, e.g., using a message, via an assessment, via a GUI, etc.

### Inferring Skill Data

Because of the information in skills database 140 for a particular skill, the services of server device 120 can automatically make inferences about the particular skill. For example, if a user has the skill “HTML” in the user's skill set, user skills service 122 infers that the user also has “HTML coding” and “HTML developing” in the skill set. Furthermore, because “HTML” is known to be a subset of “Web development”, user skills service 122 infers that the user also has “Web development” in the skill set.

As a further example, if a particular career requires a “programming language” skill, skills coordinator service 126 may consider that a “Java” skill or “C#” skill of a particular user fulfills the “programming language” skill requirement based on information in skills database 140 that “Java” and “C#” are kinds of “programming language”. In contrast, if skills database 140 does not have information that “HTML” is a kind of “programming language” or skills database 140 indicates that “HTML” is not a kind of “programming language”, then skills coordinator service 126 does not identify “HTML” as fulfilling the “programming language” skill requirement for the particular career.

A user may provide, to user skills service 122, a job title either directly or through uploading a resume, etc. According to an embodiment, user skills service 122 identifies skills to attribute to the user by inferring skills for the job title. For example, user skills service 122 may automatically determine that people who have a particular job title generally have skills A, B, and C based in part on the skills association confidence metric. Thus, when a user declares having had a particular job title, user skills service 122 infers that the user also has skills A, B, and C. As a further example, user skills service 122 infers skills from words in the job title.

Furthermore, a user may provide, to user skills service 122, education information either directly or through uploading a resume, etc. Such education information includes one or more of: educational courses taken, degrees received, certificates received, major courses of study, minor courses of study, etc. According to an embodiment, user skills service 122 identifies skills to attribute to the user by inferring skills for the education information. For example, user skills service 122 may identify that people who have taken a particular educational course or who have studied a particular major course of study, etc., generally have skills A, B, and C. Such information may come from declared skills for educational courses indicated in the educational information, etc. Thus, when a user declares the educational information, user skills service 122 infers that the user also has skills A, B, and C.

According to an embodiment, information that is automatically identified or inferred by opportunity skills service 124 is placed into a list to be confirmed by human editors. Such a list reduces the cost of obtaining information from human editors because the amount of time that the human editor must search for skills associated with particular opportunities is decreased. According to another embodiment, information that is automatically identified or inferred by opportunity skills service 124 is used at a lower level of reliability (i.e., less than 100%) than information that was gathered and/or confirmed by human editors, which would be given the highest level of reliability (i.e., 100%).

### Gathering User Data

According to a further embodiment, the graphical user interfaces produced by skills coordinator service 126 provide feedback mechanisms by which a user may rate or make comments on particular opportunities, and/or adjust the skills associated with particular opportunities. Specifically, a user may indicate that a particular opportunity does not require a particular skill that is currently listed as required for the opportunity. Further, a user may indicate that a particular educational course does not teach one or more of the skills associated therewith in skills database 140. Similarly, a user may identify skills that should be associated with particular opportunities.

Opportunity skills service 124 uses this user-supplied data to adjust skills database 140 to make the stored data more accurate. For example, opportunity skills service 124 records user-supplied data on skill associations in skills database 140. Opportunity skills service 124 adjusts data in skills database 140 when there are at least a threshold number of user-supplied data indicating that a particular change should be made. Furthermore, users may submit information indicating that a title of an opportunity or skill should be changed, or disambiguated by creating a second skill that covers at least part of what the original skill covered.

Any information stored in skills database 140 may be adjusted based, at least in part, on user-supplied data about the information. Such information may be published to skills database 140 at a lesser confidence level than 100%. Furthermore, any user-supplied data may be submitted to a human editor for vetting, and the human editor may change skills database 140.

In an embodiment, Skills Database 140 stores data about skills. For example, Skills Database 140 may be a graph database or other NoSQL (Not only SQL) database. When skills are stored as a graph, it is possible to store the fact that user A made an assertion about a skill. For example, the user may indicate that a skill is not taught by a particular course, or that the user needs to refine this skill. At runtime, user skill service 122 may decide whether or not to trust user A. For example, data about the skill may be aggregated, and user skill service 122 would look for a specified % of confidence in an assertion or determine a confidence level, which user A has influence on. Assertions that have been made to alter confidence levels or relationships within the graph may also be aggregated.

The reputation of user A may be used to help decide what to do with the assertion user A made. For example, assertions made by user A may be compared to assertions made by other users. In particular, assertions that user A made about particular skills may be compared to assertions made about those same skills by other users that have shown a certain degree of expert knowledge in those skills in an independently verifiable way such as an assessment. In general, all kinds of assertions may be stored, and various processes may be used to decide weighting or confidence in skill relationships.

### Example Methods for Recommendation

In an embodiment, profiles are maintained for users. These profiles may identify various user attributes, including the level of mastery achieved with respect to particular skills. The profiles may be maintained in a skills database 140 or a separate database system. Skills database 140 maps skills to opportunities. For example, skills database 140 may map skills to job postings, educational courses, job titles, or any other career or educational opportunity.

In an embodiment, a user requests an opportunity. One or more of services 122-126 perform a comparison between associated with the first user, and skills in the skills database to determine one or more matching skills. Based at least in part on the one or more matching skills, one or more of services 122-126 present one or more opportunities associated with the matching skills to the user.

In an embodiment, the request from the user is a request for a course recommendation and the one or more opportunities include a first educational course. One or more of services 122-126 determine, for the first user, a first skill metric associated with a first skill based on information known about a second user. In particular, a skill metric associated with a second user for the first skill may be used to determine the skill metric associated with the first user. In this embodiment, the skill metric may indicate a level of mastery of the first skill that the first user possesses. The second user's skill metric may be more reliable because the second user may have demonstrated a certain level of skill mastery by taking assessments, taking certain courses, by self-identifying mastery levels, or by providing transcripts that indicate mastery. By associating the demonstrated mastery information with a particular skill level for the second user, mastery information for the first user can be used to create a normalized skill level for the first user. For example, if the first user has taken the same courses as the second user but has performed poorly by comparison on the same assessments, then the first user may be assigned a skill level of 5 based on the second user's assigned skill level of 8 for the same skill. As more users are compared to one another, the skill levels become more normalized.

One or more of services 122-126 determine another skill metric for the first course (for the first skill) in an embodiment. Based at least in part on the user's skill metric and the course skill metric, services 122-126 determine an opportunity recommendation to present to the first user. The recommendation may be determined in response to determining that the user's skill level is lower than the skill level associated with the course.

In an embodiment, a minimum skill level is determined for the first course, indicating a level of mastery of the first skill recommended for taking the course. The recommendation may be determined based at least in part on determining that the first skill level associated with the user is greater than or equal to the minimum skill level.

In an embodiment, one or more of services 122-126 determine an anticipated skill metric based at least in part on the other known skill metrics for the user and the courses the user is taking. The anticipated skill metric represents a prediction of the new skill level that will be associated with the user's skill metric after the user completes a course. The anticipated skill metric can be presented to the user. Other anticipated skill metrics may be determined based on other courses the user is planning to take (e.g., has signed up for). The anticipated skill metrics can be used to generate a list of jobs (titles and/or specific job postings) that the user is expected to qualify for in the future. The entire list or a portion of the list may be presented to the user. The list may be ranked based on any metric data. For example, the list may be ranked based on the difference between the aggregate skill levels required for each job and the aggregate skill levels that the user currently possesses for the required skills. The list may also be ranked based on a time metric associated with each course required to achieve the optimal skill level required for the job. For example, if a first course is expected to take three months to complete and would qualify the user for a first job while a second course is expected to take six months to complete and would qualify the user for a second job, then the first job may be listed first. The same combination may be used to rank courses, assigning a higher ranking to the course that leads to a quicker job qualification for that user. In an embodiment, ranking can be configured by the user. For example, the user may choose a ranking based on the highest paid job, with a secondary ranking based on time to qualification.

In an embodiment, the first request is a request for a job recommendation and the one or more opportunities include a first job title. One or more of services 122-126 determine, for the user, a first skill metric associated with a first skill of the one or more skills. The first skill metric indicates a level of mastery of the first skill that the first user possesses. A second skill metric for a second skill is also determined for the user.

Another skill metric is determined for the first job title indicating a skill level of the first skill required to be a successful candidate for a job having the first job title. An additional skill metric for another skill associated with the job title is also determined by one or more of services 122-126.

In an embodiment one or more of services 122-126 determine a recommendation to present to the first user based at least in part on the skill metrics associated with the user and the skill metrics associated with the job title. In response to determining that the skill level identified by the first skill metric is lower than the skill level identified by the third skill metric, one or more of services 122-126 identifies a course having a skill metric for the first skill, wherein the skill level is greater than the skill level identified by the first skill metric. The user then receives a recommendation for a course that has either the skill metric desired by the user or the minimum skill metric required to take the course, as the skill metric associated with the course could represent either scenario.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

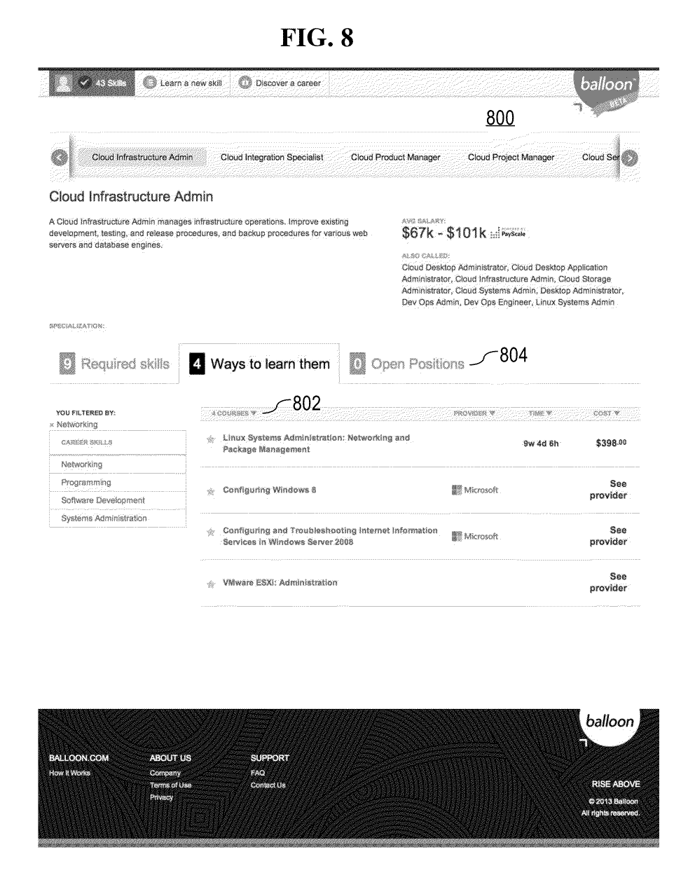

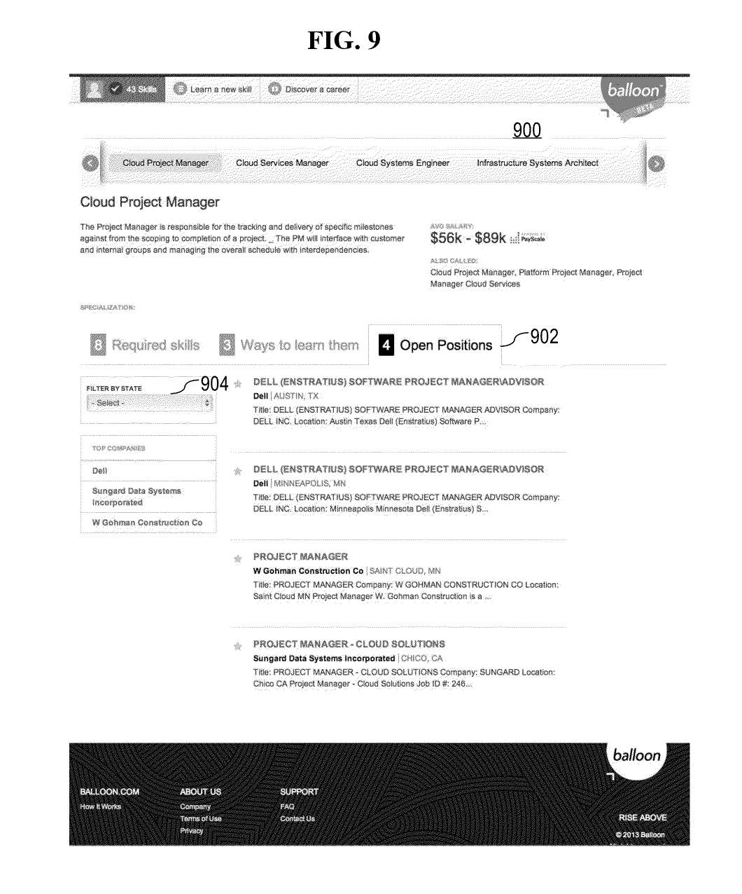

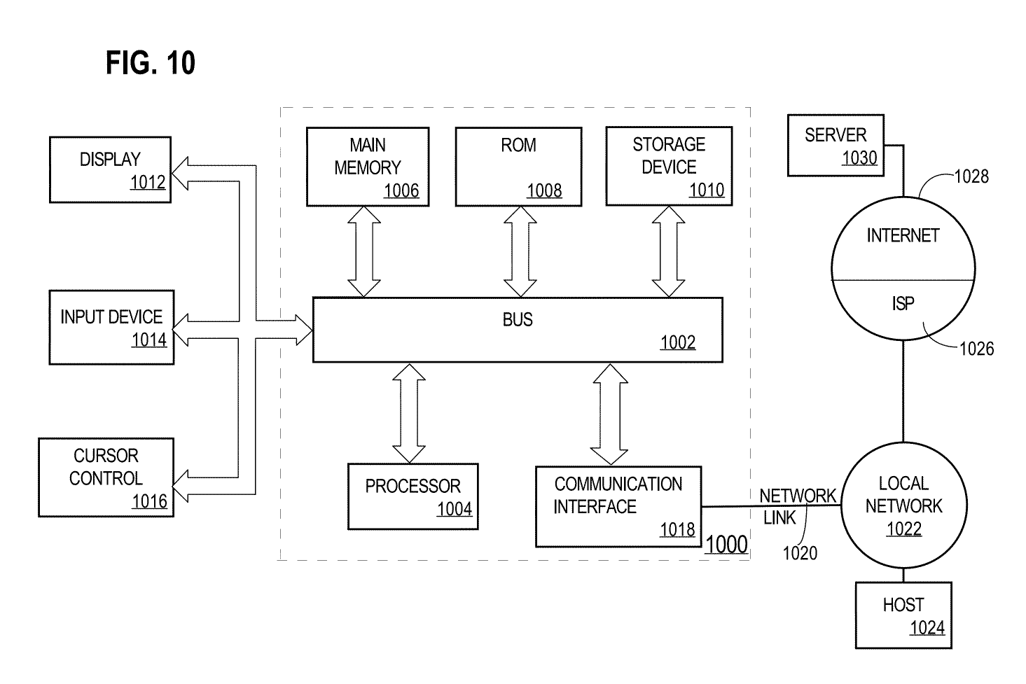

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method, comprising:
maintaining profiles for a plurality of users, wherein the profile maintained for each user identifies one or more skills associated with the corresponding user of the plurality of users;
maintaining a skills database, wherein the skills database maps one or more skills to one or more opportunities;
in response to a first request from a first user of the plurality of users, performing a comparison between a) the one or more skills associated with the first user, and b) one or more skills in the skills database to determine one or more matching skills;
based at least in part on the one or more matching skills, presenting one or more opportunities to the first user, wherein the one or more opportunities are opportunities that are associated with at least one of the one or more matching skills;
wherein the method is performed by one or more computing devices.

2. The method of claim 1, wherein the first request is a request for a course recommendation and the one or more opportunities include a first course.

3. The method of claim 2, further comprising:
determining, for the first user, a first skill metric associated with a first skill of the one or more skills based at least in part on a second skill metric, wherein the second skill metric is a skill metric associated with a second user for the first skill;
wherein the first skill metric indicates a level of mastery of the first skill that the first user possesses;
determining, for the first course, a third skill metric associated with the first skill;
determining a recommendation to present to the first user based at least in part on the first skill metric and the third skill metric.

4. The method of claim 3, wherein the recommendation is determined in response to determining that the skill level associated with the first skill metric is lower than the skill level associated with the third skill metric.

5. The method of claim 4, further comprising:
determining, for the first course, a minimum skill metric associated with the first skill, wherein the minimum skill metric indicates a level of mastery of the first skill recommended for taking the course;
wherein the recommendation is determined based at least in part on determining that the first skill level associated with the first skill metric is greater than or equal to the skill level associated with the minimum skill metric.

6. The method of claim 5, further comprising:
determining a first anticipated skill metric based at least in part on the minimum skill metric, the first skill metric, and the third skill metric, wherein the first anticipated skill metric represents a prediction of the new skill level that will be associated with the first skill metric after the user completes the first course;
presenting the first anticipated skill metric to the user.

7. The method of claim 6, comprising:
determining a second anticipated skill metric, wherein the second anticipated skill metric represents a prediction of a skill level that will be associated with a fourth skill metric after the user completes a second course;
in response to determining the first anticipated skill metric and the second anticipated skill metric, determining a first list of one or more jobs that the user is expected to qualify for when the first course and the second course have been completed by the first user;
presenting at least a portion of the first list of the one or more jobs to the first user.

8. The method of claim 1, wherein the first request is a request for a job recommendation and the one or more opportunities include a first job title.

9. The method of claim 8, further comprising:
determining, for the first user, a first skill metric associated with a first skill of the one or more skills, wherein the first skill metric indicates a level of mastery of the first skill that the first user possesses;
determining, for the first user, a second skill metric associated with a second skill of the one or more skills, wherein the second skill metric indicates a level of mastery of the second skill that the first user possesses;
determining, for the first job title, a third skill metric associated with the first skill, wherein the third skill metric indicates a skill level of the first skill required to be a successful candidate for a job having the first job title;
determining, for the first job title, a fourth skill metric associated with the second skill, wherein the fourth skill metric indicates a skill level of the second skill required to be a successful candidate for a job having the first job title;
determining a recommendation to present to the first user based at least in part on the first skill metric, the second skill metric, the third skill metric, and the fourth skill metric.

10. The method of claim 9, further comprising:
in response to determining that the skill level identified by the first skill metric is lower than the skill level identified by the third skill metric, identifying a first course associated with a fifth skill metric for the first skill, wherein the skill level identified by the fifth skill metric is greater than the skill level identified by the first skill metric;
recommending the first course to the user.

11. A computer-readable non-transitory storage medium storing instructions which, when executed by one or more processors, cause the one or more processors to perform:
maintaining profiles for a plurality of users, wherein the profile maintained for each user identifies one or more skills associated with the corresponding user of the plurality of users;
maintaining a skills database, wherein the skills database maps one or more skills to one or more opportunities;
in response to a first request from a first user of the plurality of users, performing a comparison between a) the one or more skills associated with the first user, and b) one or more skills in the skills database to determine one or more matching skills;
based at least in part on the one or more matching skills, presenting one or more opportunities to the first user, wherein the one or more opportunities are opportunities that are associated with at least one of the one or more matching skills.

12. The computer-readable non-transitory storage medium of claim 11, wherein the first request is a request for a course recommendation and the one or more opportunities include a first course.

13. The computer-readable non-transitory storage medium of claim 12, wherein the instructions further include instructions for:
determining, for the first user, a first skill metric associated with a first skill of the one or more skills based at least in part on a second skill metric, wherein the second skill metric is a skill metric associated with a second user for the first skill;
wherein the first skill metric indicates a level of mastery of the first skill that the first user possesses;
determining, for the first course, a third skill metric associated with the first skill;
determining a recommendation to present to the first user based at least in part on the first skill metric and the third skill metric.

14. The computer-readable non-transitory storage medium of claim 13, wherein the recommendation is determined in response to determining that the skill level associated with the first skill metric is lower than the skill level associated with the third skill metric.

15. The computer-readable non-transitory storage medium of claim 14, wherein the instructions further include instructions for:
determining, for the first course, a minimum skill metric associated with the first skill, wherein the minimum skill metric indicates a level of mastery of the first skill recommended for taking the course;
wherein the recommendation is determined based at least in part on determining that the first skill level associated with the first skill metric is greater than or equal to the skill level associated with the minimum skill metric.

16. The computer-readable non-transitory storage medium of claim 15, wherein the instructions further include instructions for:
determining a first anticipated skill metric based at least in part on the minimum skill metric, the first skill metric, and the third skill metric, wherein the first anticipated skill metric represents a prediction of the new skill level that will be associated with the first skill metric after the user completes the first course;
presenting the first anticipated skill metric to the user.

17. The computer-readable non-transitory storage medium of claim 16, wherein the instructions further include instructions for:
determining a second anticipated skill metric, wherein the second anticipated skill metric represents a prediction of a skill level that will be associated with a fourth skill metric after the user completes a second course;
in response to determining the first anticipated skill metric and the second anticipated skill metric, determining a first list of one or more jobs that the user is expected to qualify for when the first course and the second course have been completed by the first user;
presenting at least a portion of the first list of the one or more jobs to the first user.

18. The computer-readable non-transitory storage medium of claim 11, wherein the first request is a request for a job recommendation and the one or more opportunities include a first job title.

19. The computer-readable non-transitory storage medium of claim 18, wherein the instructions further include instructions for:
determining, for the first user, a first skill metric associated with a first skill of the one or more skills, wherein the first skill metric indicates a level of mastery of the first skill that the first user possesses;
determining, for the first user, a second skill metric associated with a second skill of the one or more skills, wherein the second skill metric indicates a level of mastery of the second skill that the first user possesses;
determining, for the first job title, a third skill metric associated with the first skill, wherein the third skill metric indicates a skill level of the first skill required to be a successful candidate for a job having the first job title;
determining, for the first job title, a fourth skill metric associated with the second skill, wherein the fourth skill metric indicates a skill level of the second skill required to be a successful candidate for a job having the first job title;
determining a recommendation to present to the first user based at least in part on the first skill metric, the second skill metric, the third skill metric, and the fourth skill metric.

20. The computer-readable non-transitory storage medium of claim 19, wherein the instructions further include instructions for:
in response to determining that the skill level identified by the first skill metric is lower than the skill level identified by the third skill metric, identifying a first course associated with a fifth skill metric for the first skill, wherein the skill level identified by the fifth skill metric is greater than the skill level identified by the first skill metric;
recommending the first course to the user.
